(19) United States
(12) Patent Application Publication
(10) Pub. No.: US 2020/0249594 A1
(43) Pub. Date: Aug. 6, 2020

(54) IMAGE FORMING APPARATUS AND STORAGE MEDIUM

(71) Applicant: KONICA MINOLTA, INC., Tokyo (JP)

(72) Inventors: Toshiki HAYAMI, Tokyo (JP); Takeshi MAEYAMA, Tokyo (JP); Tomo KITADA, Yokohama-shi (JP); Takashi KAWANAGO, Tokyo (JP); Daisuke MURAKAMI, Tokyo (JP)

(73) Assignee: KONICA MINOLTA, INC., Tokyo (JP)

(21) Appl. No.: 16/775,309

(22) Filed: Jan. 29, 2020

(30) Foreign Application Priority Data
Feb. 6, 2019 (JP) 2019-019690

(51) Int. Cl. G03G 15/16

(52) U.S. Cl. CPC G03G 15/1605

(57) ABSTRACT

An image forming apparatus includes an image holder, an intermediate transfer body, a transfer member, a pressing force changer, and a hardware processor. The intermediate transfer body includes a base layer and a coating layer provided on the base layer. The image forming apparatus transfers a toner image formed on the image holder to a sheet via the intermediate transfer body, thereby forming an image on the sheet. The transfer member is provided so as to face the image holder with the intermediate transfer body in between and forms a nip part with the image holder. The pressing force changer changes pressing force of the transfer member against the image holder. The hardware processor controls, with the pressing force changer, the pressing force of the transfer member against the image holder based on information on a surface profile of the sheet on which the image is to be formed.

### CROSS-REFERENCE TO RELATED APPLICATIONS

The entire disclosure of Japanese Patent Application No. 2019-019690 filed on Feb. 6, 2019 is incorporated herein by reference in its entirety.

### BACKGROUND

### 1. Technological Field

The present disclosure relates to an image forming apparatus and a storage medium.

### 2. Description of the Related Art

There has been widely utilized a conventional intermediate transfer image forming apparatus that firstly transfers (first transfer) a toner image formed on a photoconductor (image holder) onto an intermediate transfer belt (intermediate transfer body) and secondly transfers (second transfer) the toner image on the intermediate transfer belt onto a sheet of paper.

There is a demand that such an image forming apparatus form an image on a sheet of paper the surface of which has an uneven profile (uneven paper), such as embossed paper, rough paper, or the like.

It is known that toner is less likely to reach the depressed or raised portions of the uneven paper in the second transfer, and transferability of toner in the second transfer (second transfer transferability) to the uneven paper deteriorates as compared with plain paper. If adhesive power of the toner to the intermediate transfer belt is larger, such a tendency is more conspicuous.

In order to reduce the adhesive power of toner to the intermediate transfer belt, it is proposed to use an intermediate transfer belt made up of a base layer and a coating layer (or, sometimes referred to as a surface layer) applied to the base layer, wherein the base layer contains polyimide (PI), and the coating layer contains an inorganic oxide, such as silicon dioxide (SiO₂), as a main component (see JP 2014-109586 A, for example). The thicker the coating layer of the intermediate transfer belt is, the greater the distance between the toner and the opposing charges is, and smaller the adhesive power of toner is. This yields high second transfer transferability.

### SUMMARY

However, the present inventors have found out, through their investigations so far, that if such an intermediate transfer belt is continuously used, transferability of toner to uneven paper deteriorates with use as shown in FIG. 14.

The factor is that the intermediate transfer belt having the coating layer is more likely to make electric-discharge products adhere to the surface thereof than the intermediate transfer belt not having the coating layer. It is considered that the adhesion of the electric-discharge products to the surface of the intermediate transfer belt lowers the pure water contact angle as shown in FIG. 15, and consequently, the toner tends to stay on the surface of the intermediate transfer belt.

It is considered that the reason why the electric-discharge products are likely to adhere to the surface of the coating layer is that silicon dioxide (SiO₂) in the coating layer has a structure in which OH-groups are bonded as terminal groups, and the electric-discharge products (NOₓ) easily adhere to the OH-groups.

Objects of the present disclosure include providing an image forming apparatus and a storage medium for maintaining high transferability of toner to uneven paper.

In order to achieve at least one of the abovementioned objects, according to an aspect of the present invention, there is provided an image forming apparatus including: an image holder; an intermediate transfer body that includes a base layer and a coating layer provided on the base layer, and via which a toner image formed on the image holder is transferred to a sheet, so that an image is formed on the sheet; a transfer member that is provided so as to face the image holder with the intermediate transfer body in between and forms a nip part with the image holder; a pressing force changer that changes pressing force of the transfer member against the image holder, and a hardware processor that controls, with the pressing force changer, the pressing force of the transfer member against the image holder based on information on a surface profile of the sheet on which the image is to be formed.

According to another aspect of the present invention, there is provided a non-transitory computer-readable storage medium storing a program that causes, of an image forming apparatus including: an image holder, and an intermediate transfer body that includes a base layer and a coating layer provided on the base layer, and via which a toner image formed on the image holder is transferred to a sheet, so that an image is formed on the sheet; a transfer member that is provided so as to face the image holder with the intermediate transfer body in between and forms a nip part with the image holder; and a pressing force changer that changes pressing force of the transfer member against the image holder, a computer to: control, with the pressing force changer, the pressing force of the transfer member against the image holder based on information on a surface profile of the sheet on which the image is to be formed.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a schematic diagram of overall configuration of an image forming apparatus in a first embodiment;

FIG. 2 is a block diagram showing main functional parts of the image forming apparatus in FIG. 1;

FIG. 3 is a schematic cross-sectional view of an intermediate transfer belt;

FIG. 4 shows an example of a setting table;

FIG. 5 is a flowchart showing steps of operation for image formation by the image forming apparatus;

FIG. 6 shows a graph showing change of a grade of transferability of toner when image forming processes were performed continuously on uneven paper after pressing force was adjusted;

FIG. 7 shows a graph showing change of a pure water contact angle when the image forming processes were performed continuously on the uneven paper after the pressing force was adjusted;

FIG. 8 is a diagram showing a second cleaner of an image forming apparatus in a second embodiment;

FIG. 9 shows an example of the setting table;

FIG. 10 is a schematic diagram of a second transfer unit of an image forming apparatus in a third embodiment;

FIG. 11 shows an example of the setting table;

FIG. 12 shows a graph showing change of the grade of transferability of toner when the image forming processes were continuously performed on the uneven paper after the pressing force was adjusted;

FIG. 13A is a diagram to explain another mode of changing tension;

FIG. 13B is a diagram to explain another mode of changing tension:

FIG. 14 is a diagram to explain a conventional problem(s); and

FIG. 15 is a diagram to explain the conventional problem.

### DETAILED DESCRIPTION OF THE EMBODIMENTS

Hereinafter, embodiments of the present invention are described with reference to the drawings. However, the scope of the invention is not limited to the disclosed embodiments.

### First Embodiment

A first embodiment of the present invention is explained.

### [Configuration of Image Forming Apparatus]

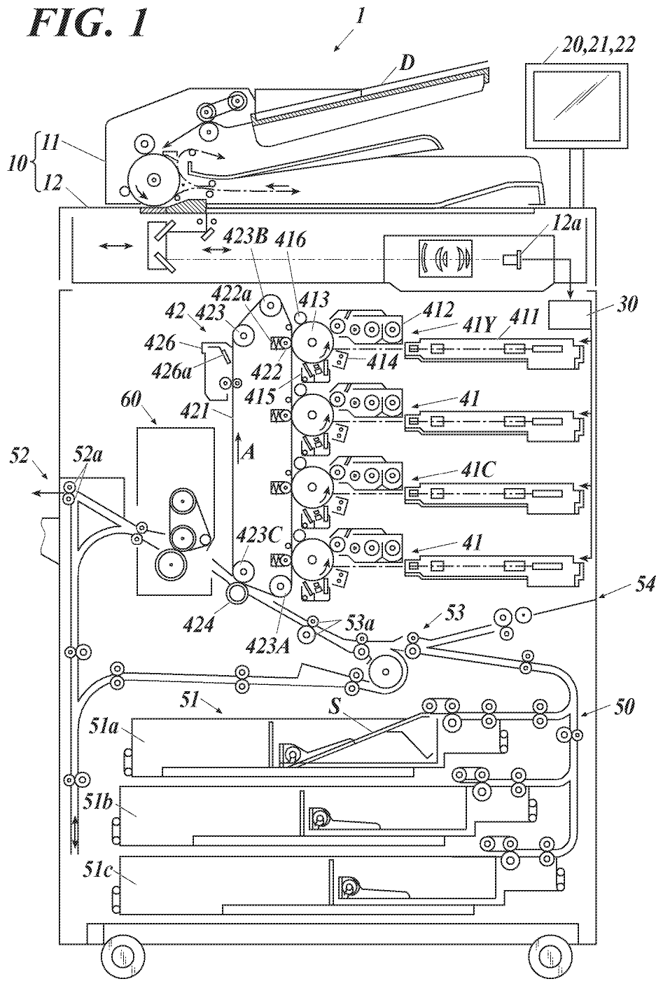

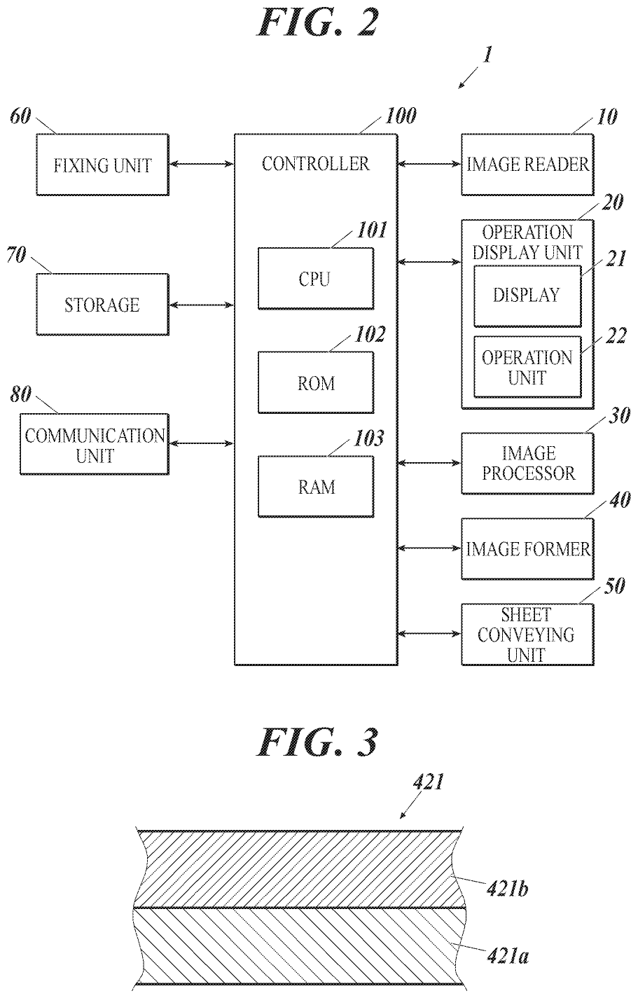

FIG. 1 is a schematic diagram of overall configuration of an image forming apparatus 1 according to this embodiment. FIG. 2 is a block diagram showing main functional parts of the image forming apparatus 1.

The image forming apparatus 1 shown in FIGS. 1 and 2 is an electrophotographic color image forming apparatus using the intermediate transfer system.

The image forming apparatus 1 employs a tandem system in which photoconductive drums 413 for four colors of Y (yellow), M (magenta), C (cyan), and K (black) are arranged in series in the moving direction of an intermediate transfer belt 421 (intermediate transfer body) to sequentially transfer toner images of the respective colors onto the intermediate transfer belt 421.

As shown in FIGS. 1 and 2, the image forming apparatus 1 includes an image reader 10, an operation display unit 20, an image processor 30, an image former 40, a sheet conveyer 50, a fixing unit 60, a storage 70, a communication unit 80, and a controller 100 (hardware processor).

The controller 100 includes a CPU (Central Processing Unit) 101, a ROM (Read Only Memory) 102, and a RAM (Random Access Memory) 103. The CPU 101 reads out programs for desired processes from the ROM 102, loads them into the RAM 103, and, in cooperation with the loaded programs, integrally controls operation of each block of the image forming apparatus 1 shown in FIG. 2.

The image reader 10 includes an auto document feeder (ADF) 11 and a document image scanner (scanner) 12.

The ADF 11 conveys, with a conveying mechanism, a document D placed on a document tray and sends it to the scanner 12. The ADF 11 allows the scanner 12 to continuously and ceaselessly read images on (both sides of) a large number of documents D placed on the document tray.

The scanner 12 optically scans each document conveyed onto a platen glass from the ADF 11 or document placed on the platen glass, and forms, on a light receiving face of a charge coupled device (CCD) sensor 12a, an image of the reflected light from the document, thereby reading the image on the document.

The image reader 10 generates input image data on the basis of the reading result by the scanner 12. The input image data is subjected to predetermined image processing performed by the image processor 30.

The operation display unit 20 includes, for example, a liquid crystal display (LCD) having a touch panel, and functions as a display 21 and an operation unit 22. The display 21 displays various operation screens, image conditions, operation statuses of functions, and the like in accordance with display control signals input by the controller 100. The operation unit 22 includes various operation keys, such as a numeric keypad and a start key, receives various types of input operations made by the user, and outputs operation signals to the controller 100.

The image processor 30 includes a circuit to perform digital image processing on image data (input image data) of an input job in accordance with initial settings or user settings. For example, the image processor 30 performs gradation correction on the basis of gradation correction data (gradation correction table) under the control of the controller 100. The image processor 30 performs various kinds of correction including color correction and shading correction as well as gradation correction, compression, and the like on the input image data. The image former 40 is controlled on the basis of the image data on which these kinds of processing have been performed.

The image former 40 includes: image forming units 41Y, 41M, 41C, and 41K to form images with toner of the respective colors, namely color components of Y, M, C, and K, on the basis of the input image data on which the image processing has been performed; and an intermediate transfer unit 42.

The image forming units 41Y, 41M, 41C, and 41K for the respective color components of Y, M, C, and K have the same configuration. For convenience of illustration and description, the parts common to the image forming units 41Y, 41C, 41M, and 41K are indicated by the same reference numerals. If any of the parts need to be specified as a part of the image forming unit 41Y, 41C, 41M, or 41K, “Y”, “M”, “C”, or “K” is added to its reference numeral. In FIG. 1, only the parts of the image forming unit 41Y, which is for the color component of Y, have reference numerals, and the reference numerals of the parts of the other image forming units 41M, 41C, and 41K are omitted.

Each image forming unit 41 includes an exposure device 411, a developing device 412, a photoconductive drum 413, a charging device 414, and a drum cleaner 415.

The exposure device 411 includes a laser light source, a polygon mirror, and a lens. The exposure device 411 scans and exposes the surface of the photoconductive drum 413 with and to a laser beam on the basis of image data in a color, thereby forming an electrostatic latent image.

The developing device 412 includes a developing sleeve provided so as to face the photoconductive drum 413 with a developing area in between. On the developing sleeve, for example, a developing bias is impressed. The developing bias is formed from an AC voltage and a DC voltage superposed on one another, the DC voltage having the same polarity as the charging polarity of the charging device 414, which is a negative polarity. With the developing bias impressed on the developing sleeve, the developing device 412 supplies a developer onto the electrostatic latent image formed on the photoconductive drum 413, thereby forming a toner image in the color on the photoconductive drum 413. The developer includes toner and carriers for charging the toner. The type of toner is not particularly limited, and toner that is widely known and commonly used can be used.

The photoconductive drum 413 consists of an organic photoconductor that includes a cylindrical metal body and a photoconductive layer. The photoconductive layer is made of resin containing an organic photoconductive matter and is formed on the outer circumferential surface of the cylindrical metal body.

The charging device 414 negatively and uniformly charges the photoconductive drum 413 to a certain potential using a charger.

The drum cleaner 415 has a drum cleaning blade or the like that slidingly contacts the surface of the photoconductive drum 413 and removes the residual toner remaining on the surface of the photoconductive drum 413 after the first transfer.

The intermediate transfer unit 42 includes an intermediate transfer belt 421, first transfer rollers 422 (transfer members), supporting rollers 423, a second transfer roller 424, and a cleaner 426.

FIG. 3 is a schematic cross-sectional view of the intermediate transfer belt 421.

As shown in FIG. 3, the intermediate transfer belt 421 in this embodiment has at least two layers: a base layer 421a and a coating layer 421b provided on the base layer 421a.

For the base layer 421a, synthetic resin, such as polyimide (PI) resin, polyamideimide resin, polyphenylene sulfide resin, or polyamide resin, with a conductive material dispersed therein is used, for example. The base layer 421a may have a single-layer structure or multi-layer structure.

The coating layer 421b is a layer that includes an inorganic oxide to which an organic component is added. For the coating layer 421b, a material that contains silicon dioxide (SiO₂) as the main component is used, for example. More specifically, for the coating layer 421b, a siloxane compound, such as methyltrimethoxysilanc, dimethyldimethoxysilane, phenyltrimethoxysilane, or methyltriethoxysilane, may be used as silicon oxide containing alkyl groups.

These are not limitations of the materials used for the base layer 421a and the coat layer 421b.

Referring back to FIGS. 1 and 2, the intermediate transfer belt 421 consists of an endless belt and is stretched around the supporting rollers 423 to be a loop.

At least one of the supporting rollers 423 is a driving roller, and the others are driven rollers. For example, the roller 423A provided downstream from the first transfer roller 422K in the moving direction of the belt is preferable as the driving roller. This makes it easy to keep the moving speed of the belt uniform at the first transfer points (i.e. first transfer nip parts described below). Rotation of the driving roller 423A makes the intermediate transfer belt 421 move in the direction indicated by an arrow A at a constant speed.

The roller 423B provided upstream from the first transfer roller 422Y in the belt moving direction has a tension adjuster (not illustrated) for adjusting the tension of the intermediate transfer belt 421. The tension adjuster includes, for example, a cam that moves a holder provided on the rotation shaft of the roller 423B in the vertical direction, and a driver that drives the cam. The driver driving the cam for a predetermined amount makes the rotation shaft and, by extension, the roller 423B move for a predetermined distance. Thus, the tension of the intermediate transfer belt 421 is adjusted.

The first transfer roller 422 is provided on the inner circumferential surface side of the intermediate transfer belt 421 so as to face the corresponding photoconductive drum 413. The first transfer roller 422 is pressed against the photoconductive drum 413 by predetermined pressing force with the intermediate transfer belt 421 in between, thereby forming a first transfer nip part for transferring a toner image from the photoconductive drum 413 to the intermediate transfer belt 421.

The first transfer roller(s) 422 in this embodiment has a pressing force changer 422a for changing pressing force of the first transfer rollers 422 against the photoconductive drum 413 (hereinafter, simply referred to as pressing force of the first transfer rollers 422).

The pressing force changer 422a includes, for example, a force supplying member that supplies force to the first transfer roller 422, such as a spring, and a driver that changes the force of the force supplying member. The force of the force supplying members can be changed by the drivers, whereby the pressing force of the first transfer rollers 422 can be changed.

More specifically, the pressing force of the first transfer rollers 422 is controlled by the controller 100 on the basis of information (surface profile information) on the surface profile of a sheet S as a target of image formation (image forming target). When the sheet S is plain paper, the pressing force of the first transfer rollers 422 is set to predetermined pressing force (F1). When the sheet S is uneven paper, the pressing force of the first transfer rollers 422 is set to pressing force (F2) that is smaller than the predetermined pressing force.

The second transfer roller 424 is provided on the outer circumferential surface side of the intermediate transfer belt 421 so as to face the opposing roller 423C provided downstream from the driving roller 423A in the belt moving direction. The second transfer roller 424 is pressed against the opposing roller 423C with the intermediate transfer belt 421 in between, thereby forming a second transfer nip part for transferring a YMCK toner image from the intermediate transfer belt 421 to the sheet S.

In each first transfer roller 422, current (transfer current) corresponding to an impressed voltage flows. This transfers the toner images developed on the surfaces of the photoconductive drums 413 sequentially onto the intermediate transfer belt 421 so as to be superposed on top of one another (first transfer) when the intermediate transfer belt 421 passes through the first transfer nip parts.

More specifically, a first transfer bias is impressed on each first transfer roller 422, so that charges having reverse polarity to that of the toner are given to the inner surface side of the intermediate transfer belt 421 (the side abutting the first transfer rollers 422). Thus, the toner images are electrostatically transferred onto the intermediate transfer belt 421.

Thereafter, when the sheet S passes through the second transfer nip part, the YMCK toner image on the intermediate transfer belt 421 is transferred onto the sheet S (second transfer). More specifically, a second transfer bias is impressed on the second transfer roller 424, so that charges having reverse polarity to that of the toner are given to the inner surface side of the sheet S (the side abutting the second transfer roller 424). Thus, the toner image is electrostatically transferred onto the sheet S. The sheet S onto which the toner image has been transferred is conveyed to the fixing unit 60.

The cleaner 426 includes a cleaning blade 426a that slidingly contacts the surface of the intermediate transfer belt 421.

The cleaning blade 426a is, for example, a plate made of urethane rubber or the like, and its tip slidingly contacts the moving intermediate transfer belt 421 and removes the residual toner, electric-discharge products, and the like remaining on the surface of the intermediate transfer belt 421 after the second transfer.

The fixing unit 60 heats and pressurizes, at a fixing nip part, the conveyed sheet S onto which the toner image has been transferred by the second transfer, thereby fixing the toner image to the sheet S.

The sheet conveyer 50 includes a sheet feeder 51, a sheet ejector 52, and a conveyance path unit 53. The sheet feeder 51 has three sheet feeding tray units 51a to 51c that accommodate sheets S by paper type as predetermined, the sheets S having been sorted on the basis of the basis weight, size, or the like. The conveyance path unit 53 has pairs of conveying rollers, such as a pair of register rollers 53a.

The sheets S accommodated in the sheet feeding tray units 51a to 51 c are sent out one by one from the top and conveyed to the image former 40 by the conveyance path unit 53. A register roller unit having the pair of register rollers 53a registers the fed sheet S and adjusts the conveyance timing. The image former 40 transfers, as the second transfer, the YMCK toner image on the intermediate transfer belt 421 onto one side of the sheet S. The fixing unit 60 then performs fixing on the sheet S. The sheet S on which the image has been formed is ejected outside the apparatus by the sheet ejector 52 having sheet ejecting rollers 52a.

In this embodiment, as sheets S, paper having an uneven surface (uneven profile on the surface), such as embossed paper, rough paper, or the like (uneven paper), is used as well as plain paper having a flat surface. When an image is formed on uneven paper as sheets S, the sheets S may be accommodated in a sheet feeding device (not illustrated) connected to the image forming apparatus 1, supplied to the image forming apparatus 1 from the sheet feeding device via a sheet feeding opening 54, and sent to the conveyance path unit 53.

The storage 70 consists of for example, a nonvolatile semiconductor memory (so-called flash memory), a hard disk drive, or the like. The storage 70 stores various types of data including information on various settings for the image forming apparatus 1.

For example, the storage 70 stores a setting table T1 that is used for image formation on sheets S.

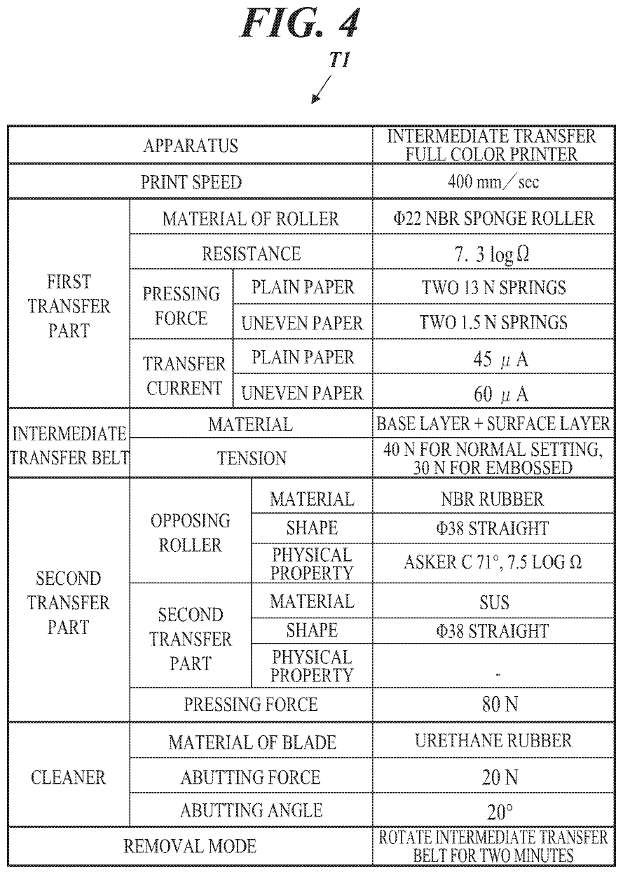

FIG. 4 shows the setting table T1.

As shown in FIG. 4, the setting table T1 stores information on settings for parts of the image forming apparatus 1 (first transfer part, intermediate transfer belt, second transfer part, and cleaner).

The first transfer part is referred to as the parts related to the first transfer, or more specifically, includes the first transfer rollers 422 and the pressing force changers 422a. The second transfer part is referred to as the parts related to the second transfer, or more specifically, includes the second transfer roller 424 and the opposing roller 423C.

The communication unit 80 consists of; for example, a communication control card, such as a LAN (Local Area Network) card, and performs data exchange with external apparatuses (e.g. personal computer) connected to communication networks, such as LAN and WAN (Wide Area Network).

### [Operation of Image Forming Apparatus]

The image forming apparatus 1 in this embodiment controls, to form an image on a sheet S, the pressing force of the first transfer rollers 422 according to the surface profile information of the sheet S as the image forming target. More specifically, when using uneven paper as the sheet S as the image forming target, the image forming apparatus 1 makes the pressing force of the first transfer rollers 422 smaller than that for plain paper as the sheet S as the image forming target. This makes it possible to maintain high transferability of toner to the uneven paper.

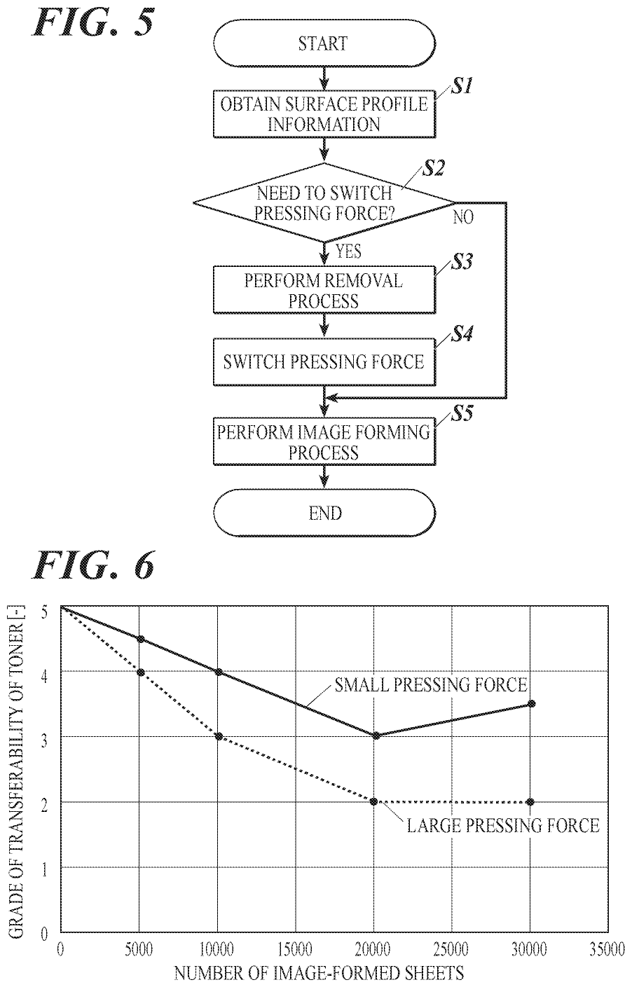

FIG. 5 is a flowchart showing steps of operation for image formation by the image forming apparatus 1.

In general, imaged are more frequently formed on plain paper than on uneven paper. Hence, in this embodiment, each part of the image forming apparatus 1 is set for forming images on plain paper when standing by for a job.

Firstly, when a user selects the paper type of sheet S as the image forming target via the operation display unit 20, the controller 100 obtains the vertical length of depressed portions or raised portions (surface profile information) of the selected paper type, the vertical length being predetermined for the paper type (Step S1).

Next, the controller 100 determines whether or not the pressing force of the first transfer rollers 422 needs to be switched on the basis of the obtained surface profile information (Step S2).

More specifically, the controller 100 determines whether or not the pressing force of the first transfer rollers 422 needs to be switched by determining whether or not the vertical length of depressed or raised portions on the surface of the sheet S is equal to or greater than a predetermined value.

When the user selects uneven paper, such as embossed paper or rough paper, the controller 100 determines that the pressing force of the first transfer rollers 422 needs to be switched. When the user selects plain paper, the controller 100 determines that the pressing force of the first transfer rollers 422 does not need to be switched.

The user may set/input the vertical length of depressed or raised portions of the sheet S as the image forming target, and the controller 100 may make the above determination on the basis of the set/input vertical length.

If the controller 100 determines that the pressing force of the first transfer rollers 422 does not need to be switched (Step S2: NO), the controller 100 proceeds to Step S5 described below.

If the controller 100 determines that the pressing force of the first transfer rollers 422 needs to switched (Step S2: YES), the controller 100 performs a removal process for removing residual toner, electric-discharge products, or the like adhering to the intermediate transfer belt 421 (Step S3).

As the removal process, the controller 100 rotates the intermediate transfer belt 421 for a predetermined time (two minutes herein), as set in the setting table T1.

The rotating time can be appropriately set or changed. Instead of the rotating time, the number of rotations of the intermediate transfer belt 421 may be set. Toner bands may be formed so as to prevent the cleaning blade 426a of the cleaner 426 from being turned up, which can occur by the removal process.

The removal process is performed before the start of the image forming process on uneven paper. In particular, it is preferable that the removal process be performed if the sheet S as the image forming target is switched from plain paper to uneven paper in order to prevent the electric-discharge products adhering to the intermediate transfer belt 421 from affecting transferability of toner to the uneven paper.

Next, the controller 100 switches the pressing force of the first transfer rollers 422 (Step S4).

More specifically, the controller 100 causes the pressing force changers 422a to operate to switch the pressing force of the first transfer rollers 422 to a set value that is set in the setting table T1. That is, the controller 100 switches the pressing force of the first transfer rollers 422 from the predetermined pressing force (F1) set for image formation on plain paper to the pressing force (F2) smaller than F1.

Also, the controller 100 refers to the setting table T1 and adjusts the tension of the intermediate transfer belt 421 and the transfer current that passes through the respective first transfer rollers 422 along with the reduction of the pressing force of the first transfer rollers 422.

More specifically, the controller 100 reduces the tension of the intermediate transfer belt 421 and increases the transfer current along with the reduction of the pressing force of the first transfer rollers 422.

Next, the controller 100 performs, with the image former 40, an image forming process for forming an image on the sheet S (Step S5), and ends the series of steps.

FIG. 6 shows a graph (solid line) showing change of the grade of transferability of toner when the image forming processes were continuously performed on uneven paper (Rezak 66 (trade name), white 203 g/m²) with the pressing force switched as described above.

For comparison, FIG. 6 also shows a graph (broken line) when the image forming processes were continuously performed on the same uneven paper with the pressing force not switched (i.e. with the setting for plain paper).

In FIG. 6, the horizontal axis represents the number of image-formed sheets, and the vertical axis represents the grade of transferability of toner [-].

The grade of transferability of toner was determined by a certain number of users on the basis of visual inspection in accordance with following criteria.

5: No problem

4: Void(s) in Halftone area

3: Void(s) in two-layer solid area made up of two layers (secondary color)

2: Void(s) in two-layer solid area or single-layer solid area made up of one layer (primary color)

1: Significant voids over the entire area

FIG. 6 shows that the reduction of the pressing force improved the grade of transferability of toner in image formation on uneven paper.

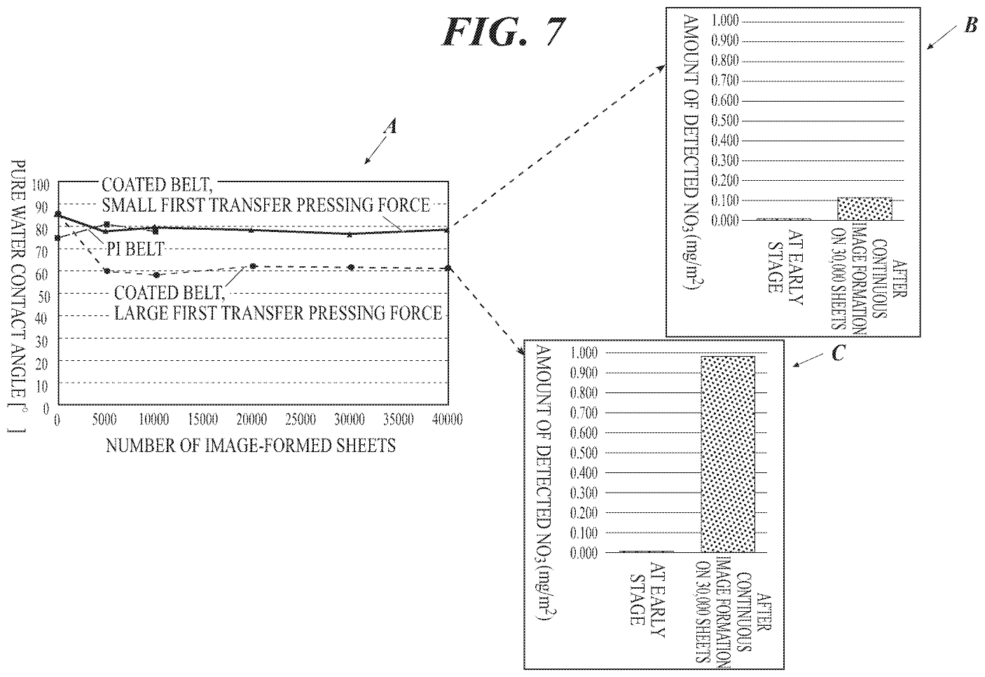

The A part in FIG. 7 shows a graph (solid line) showing change of the pure water contact angle when the image forming processes were continuously performed on uneven paper (Rezak 66, white 203 g/m²) with the pressing force switched as described above.

For comparison, the A part in FIG. 7 also shows a graph (broken line) showing the case where the image forming processes were continuously performed on the same uneven paper without switching the pressing force (i.e. with the setting for plain paper).

In the A part in FIG. 7, the horizontal axis represents the number of image-formed sheets, and the vertical axis represents the pure water contact angle [°].

B and C parts in FIG. 7 are graphs showing amounts of detected electric-discharge products (NOₓ) (i) at the early stage and (ii) after the image formation on 30,000 sheets, in the image forming processes with the respective settings.

The A to C parts in FIG. 7 show that, in the case of reducing the pressing force of the first transfer rollers 422, the adhesion amount of electric-discharge products after the continuous image forming processes decreased as compared with the case of not reducing the pressing force.

In general, in order to prevent generation of electric-discharge products, the pressing force of first transfer rollers is increased. More specifically, in order to prevent generation of electric-discharge products, the first transfer voltage (bias) is lowered; and in order to lower the first transfer voltage, the first transfer nip parts need to be as wide as possible. Thus, the pressing force of the first transfer rollers is increased.

However, in the present disclosure, the pressing force of the first transfer rollers 422 is reduced.

Because the first transfer nip parts narrow and the transfer voltage is increased owing to the reduction of the pressing force, the amount of the generated electric-discharge products is considered to increase. On the basis of the results shown in the A to C parts in FIG. 7, however, the reduction of the pressing force is considered to reduce the adhesive power of electric-discharge products.

The electric-discharge products having weaker adhesive power can be removed by being rubbed with the cleaner 426 for the intermediate transfer belt 421, sheets S, or the second transfer part at the time of second transfer.

Thus, in the case of forming images on uneven paper, the transferability of toner is maintained by making the pressing force of the first transfer rollers 422 smaller than that in the normal setting.

As described above, it was revealed that, in maintaining transferability of toner, reducing the adhesive power of electric-discharge products to the belt by reducing the pressing force of the first transfer rollers was more effective than reducing the amount of generated electric-discharge products by increasing the pressing force of the first transfer rollers.

It is desirable that the pressing force for plain paper be set, as the normal setting, to be stronger than that for uneven paper. Weaker pressing force requires a higher transfer voltage, which may shorten the life of each part. Weaker pressing force may also generate white voids in a formed image due to foreign matters being sandwiched between the intermediate transfer belt 421 and the photoconductive drums 413. Therefore, the normal setting (i.e. stronger pressing force) is preferred whenever possible. Uneven paper does not suffer from the occurrence of white voids because the white voids on the uneven paper, which has an uneven surface profile, are less noticeable than on plain paper.

Although the normal pressing force leads to a more adhesion amount of electric-discharge products, transferability of toner to paper other than uneven paper is hardly affected by electric-discharge products, and consequently maintained at a high level. This is because in the second transfer the paper other than uneven paper closely contacts the second transfer nip part.

### Advantageous Effects of Embodiment

As described above, according to this embodiment, in the intermediate transfer image forming apparatus 1, the intermediate transfer belt 421 has the base layer 421a and the coating layer 421b provided on the base layer 421a. The image forming apparatus in this embodiment includes: the first transfer rollers 411 that are provided so as to face the respective photoconductive drums 413 with the intermediate transfer belt 421 in between and form the nip parts with the photoconductive drums 413; the pressing force changers 422a that change the pressing force of the first transfer rollers 422 against the photoconductive drums 413; and the controller 100 that controls, with the pressing force changer 422a, the pressing force of the first transfer rollers 422 against the photoconductive drums 413 on the basis of surface profile information of the sheet S on which the image is to be formed.

More specifically, in response to the sheet S as the image forming target being uneven paper, on the basis of the information, the controller 100 makes the pressing force of the first transfer rollers 311 against the photoconductive drums 413 smaller than the pressing force thereof for the sheet S as the image forming target being plain paper.

Thus, the image forming apparatus 1 employs the intermediate transfer belt 421 having the coating layer 421b and can form an image on uneven paper. When forming images on the uneven paper, the apparatus makes the pressing force of the first transfer rollers 422 smaller than usual. This allows the electric-discharge products, which may adhere to the intermediate transfer belt 421, to be easily removed therefrom. Consequently, high transferability of toner to uneven paper is maintained.

Further, because the electric-discharge products, which may adhere to the intermediate transfer belt 421, can be easily removed therefrom, the controller 100 does not need to perform the removal process frequently and can maintain high transferability of toner without decreasing productivity.

Furthermore, according to this embodiment, the controller 100 makes the tension of the intermediate transfer belt 421 smaller as the hardware processor makes the pressing force of the first transfer rollers 422 against the photoconductive drums 413 smaller.

Thus, bad effects of pushback of the intermediate transfer belt 421 due to the reduction of the pressing force of the first transfer rollers 422 is reduced, and hence an appropriate image forming condition is secured.

Furthermore, according to this embodiment, the controller 100 reduces the pressing force of the first transfer rollers 422 against the photoconductive drums 413 and increases the transfer current.

Thus, an appropriate image forming condition is secured.

In the above embodiment, the controller 100 obtains the surface profile information in response to the setting operation by the user. However, the sheet feeder 51 or the conveyance path unit 53 may be provided with a sheet detector that detects the vertical length of depressed or raised portions of the sheet S (surface profile information), and the controller 100 may determine whether or not the pressing force needs to be switched on the basis of the detection result by the sheet detector.

Furthermore, in the above embodiment, the controller 100 performs control to switch the pressing force between two levels, namely between the pressing force for plain paper and that for uneven paper, as set in the setting table T1, as an example. The controller 100 may perform control to switch the pressing force between multiple levels on the basis of the vertical length of depressed portions or raised portions of uneven paper.

That is, in response to the sheet S as the image forming target being uneven paper, the controller 100 may make the pressing force of the first transfer rollers 422 against the photoconductive drums 413 smaller as the vertical length of depressed or raised portions of the sheet S is longer, the vertical length being the information.

Thus, the pressing force of the first transfer rollers 422 is adjusted for each type of uneven paper, so that higher transferability of toner to uneven paper is maintained.

### Second Embodiment

A second embodiment of the present disclosure is described with a focus on points different from the first embodiment.

The parts same as those in the first embodiment are denoted by the same reference numerals, and descriptions thereof are omitted.

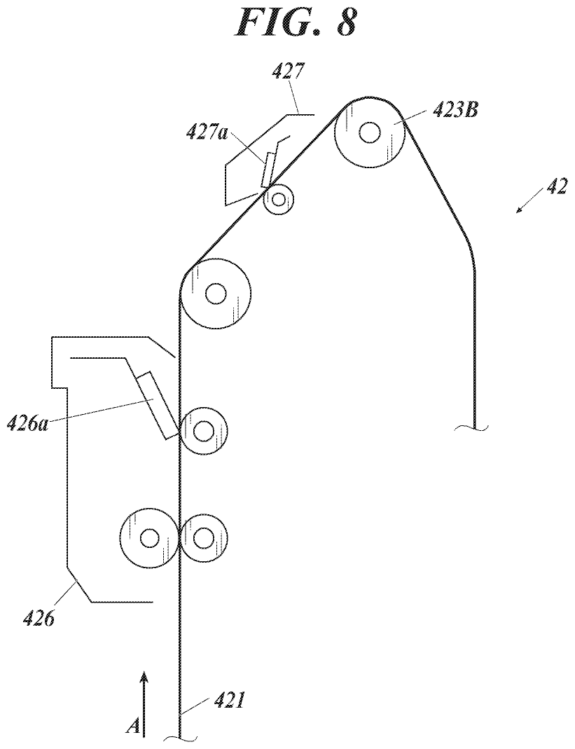

FIG. 8 is a diagram showing main parts of an image forming apparatus in this embodiment.

As shown in FIG. 8, the image forming apparatus in this embodiment is the image forming apparatus 1 in the first embodiment provided with a second cleaner 427.

That is, an intermediate transfer unit 42 of the image forming apparatus in this embodiment includes an intermediate transfer belt 421, first transfer rollers 422, supporting rollers 423, a second transfer roller 424, a cleaner 426, and a second cleaner 427.

The second cleaner 427 removes electric-discharge products adhering to the intermediate transfer belt 421 and collects residual toner that the cleaner 426 (first cleaner) has been unable to remove (the toner that has escaped the cleaner 426).

The second cleaner 427 is provided downstream from the cleaner 426 and upstream from the first transfer roller 422Y in the moving direction of the intermediate transfer belt 421.

The second cleaner 427 includes a cleaning blade 427a supported by a supporter (not illustrated).

The cleaning blade 427a is, for example, a plate made of metal, such as SUS (stainless steel), and its tip slidingly contacts the circling intermediate transfer belt 421. Thus, the cleaning blade 427a removes electric-discharge products and residual toner on the intermediate transfer belt 421.

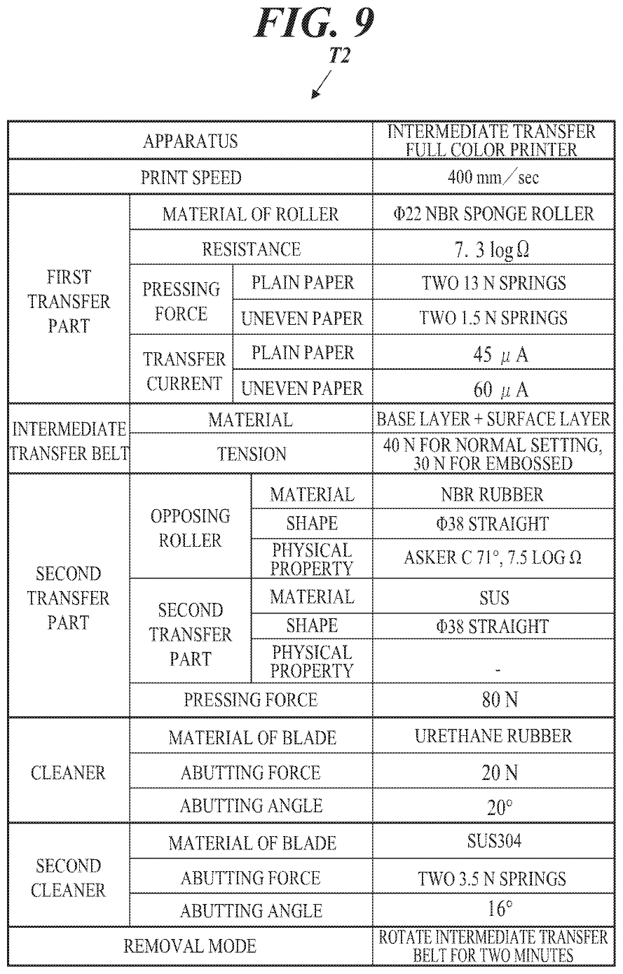

FIG. 9 shows a setting table T2 stored in the storage 70 of the image forming apparatus in this embodiment. As shown in FIG. 9, the setting table T2 stores information on settings for parts of the image forming apparatus (first transfer part, intermediate transfer belt, second transfer part, (first) cleaner, and second cleaner).

By using not only a rubber blade but also a metal blade having a high hardness, electric-discharge products can be effectively removed.

In this embodiment, the cleaning blade 427a is made of SUS304 as an example. By using the cleaning blade 427a coated with DLC (Diamond-Like Carbon), the electric-discharge products can be more effectively removed.

### Third Embodiment

A third embodiment of the present disclosure is described with a focus on points different from the second embodiment.

The parts same as those in the second embodiment are denoted by the same reference numerals, and descriptions thereof are omitted.

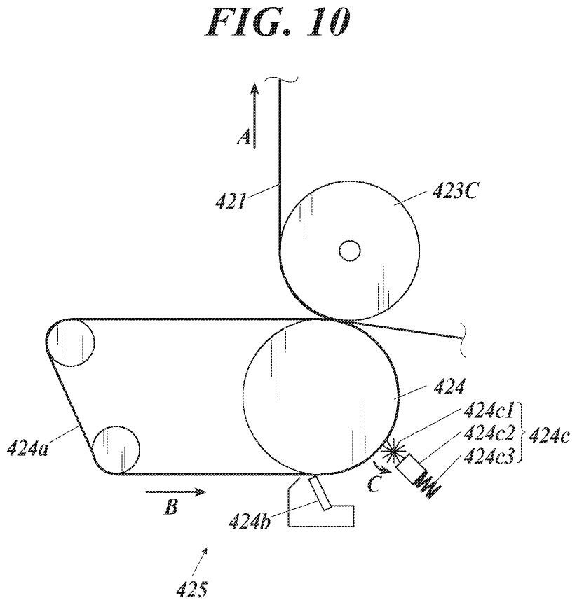

FIG. 10 is a diagram showing main parts of an image forming apparatus in this embodiment.

As shown in FIG. 10, the image forming apparatus in this embodiment includes a second transfer unit 425 into which a plurality of parts including a second transfer roller 424 are unitized, instead of the second transfer roller 424 of the image forming apparatus in the second embodiment.

The second transfer unit 425 includes a second transfer roller 424, an endless second transfer belt 424a stretched around the second transfer roller 424 and supporting rollers to be a loop, a cleaner 424b that abuts the second transfer belt 424a and scrapes off residues on the second transfer belt 424a, and a lubricant applier 424c that applies a lubricant to the second transfer belt 424a.

The lubricant applier 424c is provided downstream from the cleaner 424b in the moving direction of the second transfer belt 424a, and applies the lubricant to the surface of the second transfer belt 424a.

The lubricant applier 424c includes an application brush 424c1, a solid lubricant 424c2, and a pressing member 424c3.

The application brush 424c1 is provided so as to abut both the solid lubricant 424c2 and the second transfer belt 424a, and in this state, rotates in the direction indicated by the arrow C in FIG. 10, thereby scraping the lubricant from the solid lubricant 424c2 and applying it to the second transfer belt 424a. The application brush 424c1 is driven to rotate by a driver (not illustrated). The application brush 424c1 may rotate opposite to the direction indicated by the arrow C in FIG. 10 according to types of system thereof.

Examples of the material of the solid lubricant 424c2 include particles of (higher) fatty acid metal salts, such as stearic acid zinc salt, stearic acid aluminum salt, stearic acid copper salt, stearic acid magnesium salt, stearic acid calcium salt, oleic acid zinc salt, oleic acid manganese salt, oleic acid iron salt, oleic acid copper salt, oleic acid magnesium salt, palmitic acid zinc salt, palmitic acid copper salt, palmitic acid magnesium salt, palmitic acid calcium salt, linoleic acid zinc salt, linoleic acid calcium salt, ricinoleic acid zinc salt, and ricinoleic acid calcium salt.

The pressing member 424c3 consists of a spring or the like, and presses the solid lubricant 424c2 against the application brush 424c1.

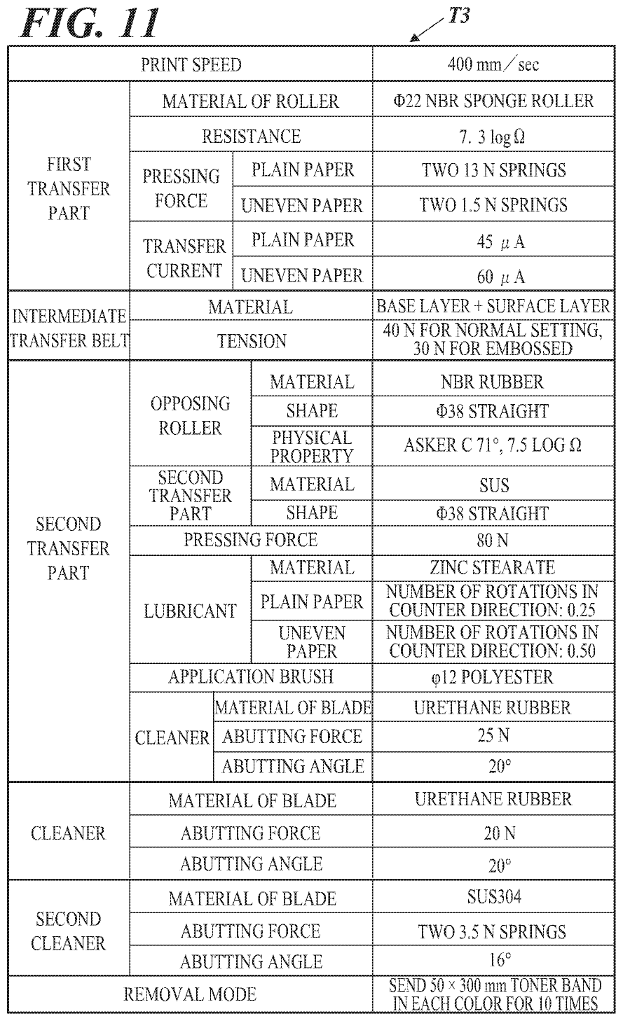

FIG. 11 shows a setting table T3 stored in the storage 70 of the image forming apparatus in this embodiment. As shown in FIG. 11, the setting table T3 stores information on settings of parts for the image forming apparatus (first transfer part, intermediate transfer belt, second transfer part, (first) cleaner, and second cleaner).

In the setting table T3, formation of toner bands is set as a removal process. In this removal process, the toner bands are sent to the cleaner 426 for the intermediate transfer belt 421. In this removal process, the toner as the toner bands sent to the cleaner 426 goes into between the cleaning blade 426a and the intermediate transfer belt 421, and serves as an abrasive for scraping off the electric-discharge products on the intermediate transfer belt 421. Thus, the electric-discharge products can be removed more quickly.

Naturally, the amount of toner to send, such as the size of the toner bands and the number of times of sending the toner bands, is not limited to the settings in the setting table T3.

FIG. 12 shows a graph (solid line) showing change of the grade of transferability of toner when the image forming processes were continuously performed on uneven paper (Rezak 66, white 203 g/m²) using the image forming apparatus in this embodiment with the pressing force switched.

FIG. 12 also shows a graph (broken line) showing change of the grade of transferability of toner when the image forming processes were continuously performed on the same uneven paper using the image forming apparatus in the first embodiment with the pressing force switched. FIG. 12 also shows a graph (two-dot chain line) when the image forming processes were continuously performed on the same uneven paper using the image forming apparatus in the first embodiment with the pressing force not switched (i.e. with the setting for plain paper).

In FIG. 12, the horizontal axis represents the number of image-formed sheets, and the vertical axis represents the grade of transferability of toner [-].

FIG. 12 shows that the use of the image forming apparatus in this embodiment further improved the grade of transferability of toner.

It is considered that the reason for this is because the electric-discharge products NOₓ(negative ions) reacted, before adhering to the surface of the intermediate transfer belt 421, with zinc Zn (positive ions) contained in the lubricant (zinc stearate or the like) applied by the second transfer unit 425, thereby forming salts. With this configuration, the electric-discharge products can be removed more effectively.

In applying the lubricant, it is preferable in terms of long life (consumption) of the lubricant that the number rotations of the application brush 424c1 be changed according to the vertical length of depressed or raised portions of the sheet S or the like. Instead of the number of rotations, the pressing force to the application brush 424c1 may be changed. In this case, the pressing force may be changed between more than two levels. The vertical length of depressed or raised portions of the sheet S may be detected by the sheet detector or determined in response to the operation on the display by the user.

In this embodiment, the lubricant is applied to the second transfer belt 424a as an example. However, the target of the application of the lubricant may be other parts that contact the intermediate transfer belt 421 (e.g. photoconductive drum). Alternatively, the lubricant may be directly applied to the intermediate transfer belt 421.

### <Others>

Embodiments to which the present invention is applicable are not limited to the embodiments described above, and the present invention can be appropriately modified within the scope of the present invention.

For example, in the first to third embodiments described above, the controller 100 performs control to reduce the tension of the intermediate transfer belt 421 when reducing the pressing force of the first transfer rollers 422. Instead of using the method of reducing the tension described above, the controller 100 may perform control to change the position at which each first transfer roller 422 abuts the intermediate transfer belt 421 (hereinafter, simply referred to as the abutting position of the first transfer roller 422) to the upstream side.

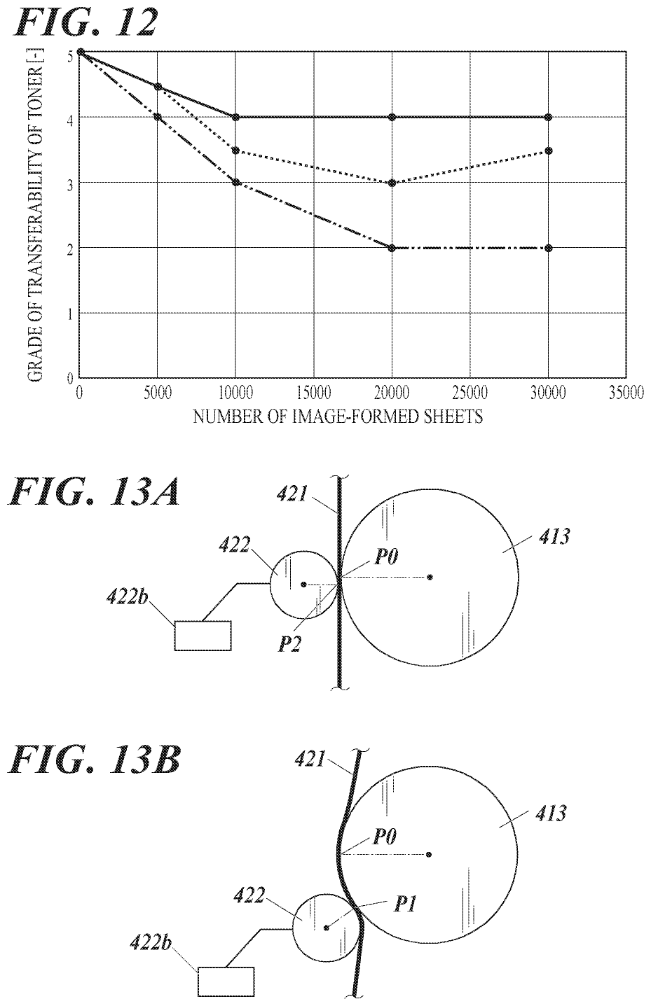

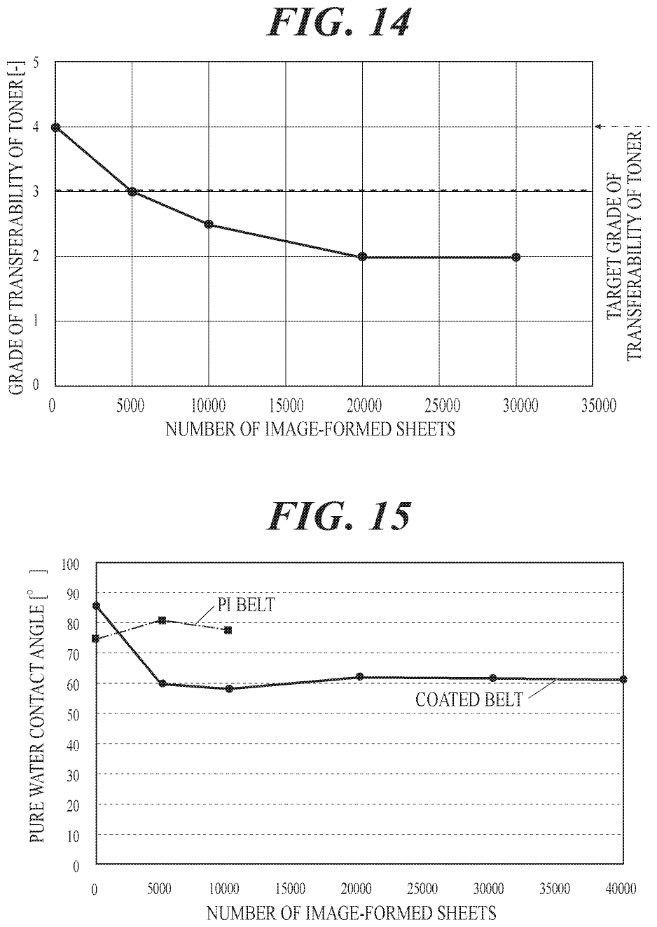

In this case, as shown in FIG. 13, each first transfer roller 422 has a mover 422b that moves the first transfer roller 422 along the moving direction of the intermediate transfer belt 421.

The mover 422b includes, for example, a cam that moves a holder being set to the rotation shaft of the first transfer roller 422, and a driver that drives the cam. The driver driving the cam for a predetermined amount makes the rotation shaft and, by extension, the first transfer roller 422 for a predetermined distance.

When the pressing force of each first transfer roller 422 is set to the pressing force F1 (i.e. when plain paper is used), the first transfer roller 422 is set at the position P1 as shown in FIG. 13B. When the pressing force of each first transfer roller 422 is set to the pressing force F2 (i.e. when uneven paper is used), the first transfer roller 422 is set at the position P2 upstream from the position P1 in the moving direction of the intermediate transfer belt 421, as shown in FIG. 13A.

In the first to third embodiments described above, the coating layer 421b that includes an inorganic oxide to which an organic component is added is explained as an example of the coating layer. Alternatively, a coating layer of an organic compound, such as urethane, acrylic, PFA (perfluoroalkoxy alkane), or PTFE (polytetrafluoroethylene), may be used as the coating layer.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
an image holder,
an intermediate transfer body that includes a base layer and a coating layer provided on the base layer, and via which a toner image formed on the image holder is transferred to a sheet, so that an image is formed on the sheet;
a transfer member that is provided so as to face the image holder with the intermediate transfer body in between and forms a nip part with the image holder;
a pressing force changer that changes pressing force of the transfer member against the image holder; and
a hardware processor that controls, with the pressing force changer, the pressing force of the transfer member against the image holder based on information on a surface profile of the sheet on which the image is to be formed.

2. The image forming apparatus according to claim 1, wherein in response to the sheet being uneven paper, based on the information, the hardware processor makes the pressing force of the transfer member against the image holder smaller than the pressing force thereof for the sheet being plain paper.

3. The image forming apparatus according to claim 1, wherein in response to the sheet being uneven paper, the hardware processor makes the pressing force of the transfer member against the image holder smaller as a vertical length of a depressed portion or a raised portion of the sheet is longer, the vertical length being the information.

4. The image forming apparatus according to claim 2, wherein the hardware processor makes tension of the intermediate transfer body smaller as the hardware processor makes the pressing force of the transfer member against the image holder smaller.

5. The image forming apparatus according to claim 2, further comprising a mover that moves the transfer member along a moving direction of the intermediate transfer body, wherein
with the mover, the hardware processor adjusts, upstream in the moving direction, a position where the transfer member is pressed against the image holder according to the pressing force of the transfer member against the image holder.

6. The image forming apparatus according to claim 1, wherein the hardware processor reduces the pressing force of the transfer member against the image holder and increases current that flows the transfer member.

7. The image forming apparatus according to claim 1, wherein
the image holder includes a plurality of image holders provided on an outer circumferential side of the intermediate transfer body along the moving direction of the intermediate transfer body, and
the image forming apparatus further comprises a metal blade that is provided upstream from the plurality of image holders in the moving direction and slidingly contacts a surface of the intermediate transfer body.

8. The image forming apparatus according to claim 1, further comprising a lubricant applier that applies a lubricant to an outer surface of the intermediate transfer body or to a part that contacts the outer surface of the intermediate transfer body.

9. The image forming apparatus according to claim 8, wherein the hardware processor controls, based on the information, an amount of the lubricant that is applied by the lubricant applier.

10. The image forming apparatus according to claim 1, wherein the hardware processor performs a removal process for removing a matter adhering to the intermediate transfer body before the image is formed on uneven paper as the sheet.

11. The image forming apparatus according to claim 10, wherein the hardware processor performs, as the removal process, operation of rotating the intermediate transfer body.

12. The image forming apparatus according to claim 10, further comprising a cleaner that is provided downstream from a position where the toner image is transferred to the sheet and upstream from a position where the toner image is formed on the image holder, wherein
the hardware processor performs, as the removal process, operation of sending a toner band to the cleaner for the intermediate transfer body.

13. The image forming apparatus according to claim 1, wherein the coating layer includes an inorganic oxide to which an organic component is added.

14. A non-transitory computer-readable storage medium storing a program that causes, of an image forming apparatus including: an image holder, an intermediate transfer body that includes a base layer and a coating layer provided on the base layer, and via which a toner image formed on the image holder is transferred to a sheet, so that an image is formed on the sheet; a transfer member that is provided so as to face the image holder with the intermediate transfer body in between and forms a nip part with the image holder; and a pressing force changer that changes pressing force of the transfer member against the image holder, a computer to:
control, with the pressing force changer, the pressing force of the transfer member against the image holder based on information on a surface profile of the sheet on which the image is to be formed.
